(19) United States
(12) Patent Application Publication
(10) Pub. No.: US 2019/0240909 A1
(43) Pub. Date: Aug. 8, 2019

(54) THREE-DIMENSIONAL OBJECT SHAPING DEVICE

(71) Applicant: MIMAKI ENGINEERING CO., LTD., Nagano (JP)

(72) Inventor: Kunio Hakkaku, Nagano (JP)

(73) Assignee: MIMAKI ENGINEERING CO., LTD., Nagano (JP)

(21) Appl. No.: 16/252,719

(22) Filed: Jan. 21, 2019

(30) Foreign Application Priority Data
Feb. 8, 2018 (JP) 2018-021234

(51) Int. Cl. B29C 64/35; B33Y 30/00; B29C 64/218; B33Y 40/00; B29C 64/227

(52) U.S. Cl. CPC B29C 64/35; B33Y 30/00; B29C 64/227; B33Y 40/00; B29C 64/218

(57) ABSTRACT

A three-dimensional object shaping device capable of appropriately collecting surplus shaping material is provided. The three-dimensional object shaping device that shapes a three-dimensional object by layering unit layers formed by ejecting a shaping material includes a flattening roller (52) that makes contact with a surface side of the unit layer to scrape off the surplus shaping material, and flattens the surface of the unit layer; a suction roller (61) serving as a removing member that is brought into contact with the flattening roller (52) to suction the shaping material attached to the flattening roller (52); and a roller rotation mechanism (62) that changes a contacting position of the suction roller (61) with respect to the flattening roller (52).

### CROSS REFERENCE TO RELATED APPLICATIONS

This application claims the priority benefit of Japanese Patent Application No. 2018-021234, filed on Feb. 8, 2018. The entirety of the above-mentioned patent application is hereby incorporated by reference herein and made a part of this specification.

### TECHNICAL FIELD

The present disclosure relates to a three-dimensional object shaping device.

### DESCRIPTION OF THE BACKGROUND ART

In recent years, a 3D printer for shaping an object having a three-dimensional shape is being used for various purposes, and, for example, a method of shaping a three-dimensional object by ejecting a shaping material, which is a material of the three-dimensional object, from an inkjet head is known for the 3D printer. In such a 3D printer that ejects the shaping material from the inkjet head, a liquid shaping material before being cured is ejected and ultraviolet rays are irradiated to the liquid shaping material to cure the shaping material and form a unit layer, and such unit layers are layered to form a layered body, thus enabling a desired three-dimensional object to be obtained.

At that time, some conventional 3D printers adjust the height while the shaping material is uncured with respect to the shaping material ejected from the inkjet head in order to improve the accuracy of the height of each unit layer constituting the layered body. For example, in the three-dimensional shaping device described in Japanese Unexamined Patent Publication No. 2013-67116, the liquid shaping material ejected from the inkjet head is brought into contact with a rotating roller and the surplus shaping material is scraped off by being attached to the roller.

Furthermore, in such a three-dimensional shaping device, the distal end of a blade for scraping off the shaping material attached to the roller is disposed in contact with the roller, and the shaping material attached to the roller is removed by the blade at a time point the shaping material is conveyed to the blade by the rotation of the roller. Moreover, the shaping material scraped off by the blade is guided to a bus that accumulates the shaping material, and is suctioned and discharged by a suction tube.

### SUMMARY

However, when scraping off the shaping material attached to the roller with the blade, the surplus shaping material that was scraped off may harden when being guided to the bus, resulting in generation of residues. Such residue may clog the suction tube, which may hinder the discharging of the shaping material accumulated in the bus, leading to an overflow of the shaping material from the bus and possibly resulting in shaping failure and device failure. Furthermore, when the residue attaches to the blade, the shaping material scraped off with the blade may flow not only in the direction of the bus but also to both ends of the blade, and the shaping material may droop down from the blade during shaping.

The present disclosure provides a three-dimensional object shaping device capable of appropriately collecting surplus shaping material.

A three-dimensional object shaping device according to the present disclosure is a three-dimensional object shaping device that shapes a three-dimensional object by layering a plurality of unit layers, wherein each unit layer of the plurality of unit layers is formed by ejecting a shaping material on a shaping table from a supply section that supplies the shaping material, the three-dimensional object shaping device includes a flattening roller that makes contact with a surface side of the unit layer to scrape off the surplus shaping material, and flattens the surface of the unit layer; and a removing member that is brought into contact with the flattening roller to remove the shaping material attached to the flattening roller.

According to this configuration, the shaping material attached to the flattening roller can be removed by the removing member. Therefore, as a configuration in which a blade is omitted in addition to a storage tank such as a bus for storing the shaping material, a pump and a suction tube of the suction drive system can be adopted, the occurrence of overflow of the shaping material from the storage tank due to the clogging of residue in the suction tube can be suppressed. Furthermore, the occurrence of drooping of the shaping material from the blade due to the attachment of residue to the blade can be suppressed. Thus, the surplus shaping material attached to the flattening roller can be appropriately removed by the removing member.

The removing member includes a removal region for removing the shaping material, the flattening roller is brought into contact with one part of the removal region; and a contacting position changing mechanism that changes a contacting position of the removing member in contact with the flattening roller from one part of the removal region to another part of the removal region is further arranged.

According to this configuration, the removal region of the removing member for removing the shaping material can be changed by changing the contacting position of the removing member. The unused removal region of the removing member thus can be sequentially supplied, whereby the removing member can be used for a long term, and the frequency of replacing the removing member can be reduced.

Furthermore, the contacting position changing mechanism changes the contacting position of the removing member by a drive source different from a drive source for driving the flattening roller, or the contacting position changing mechanism changes the contacting position of the removing member by a power branched from a power transmitted from the drive source for driving the flattening roller to the flattening roller, or the contacting position changing mechanism changes the contacting position of the removing member by making contact with the flattening roller to be driven by the rotation of the flattening roller.

According to such configuration, the contacting position of the removing member can be changed by using a drive source different from the drive source for driving the flattening roller, using the drive source of the flattening roller, or using the rotation of the flattening roller.

Moreover, when using a drive source different from a drive source for driving the flattening roller or when using power branched from the power transmitted from the drive source for driving the flattening roller to the flattening roller, the contacting position changing mechanism moves the removing member in a direction opposing the rotating direction of the flattening roller to change the contacting position of the removing member; and the moving speed of the removing member is slower than a circumferential speed of the flattening roller.

According to such configuration, the shaping material attached to the flattening roller can be suitably removed by moving the removing member in the direction opposing the rotating direction of the flattening roller. Furthermore, the removing member can be used for a longer term, and the frequency of replacing the removing member can be reduced by making the moving speed of the removing member slower than the circumferential speed of the flattening roller.

Furthermore, the removing member is a suction roller that makes contact with the flattening roller; and the contacting position changing mechanism is a roller rotation mechanism that rotates the suction roller.

According to such configuration, the surplus shaping material can be suctioned by the suction roller by bringing the suction roller into rolling contact with the flattening roller.

Furthermore, the removing member is an endless belt that makes contact with the flattening roller, and the contacting position changing mechanism is a belt circulating mechanism that circulates the endless belt.

According to such configuration, the surplus shaping material can be suctioned by the endless belt by bringing the endless belt into contact with the flattening roller and circulating it.

The removing member is a web that makes contact with the flattening roller, and is fed out from a feeding roll and wound around a winding roll, and the contacting position changing mechanism is a winding roll rotation mechanism that rotates the winding roll.

According to such configuration, the surplus shaping material can be suctioned by the web by bringing the web into contact with the flattening roller and winding it with the winding roll.

A cleaning nozzle that sprays cleaning liquid for removing the shaping material on the removing member is further arranged.

According to such configuration, since the removing member can contain the cleaning liquid, the removal of the shaping material by the cleaning liquid can be promoted, so that the removal of the shaping material by the removing member can be suitably performed.

The three-dimensional object shaping device according to the present disclosure has the effect of being able to appropriately collect the surplus shaping material.

### BRIEF DESCRIPTION OF THE DRAWINGS

FIG. 1 is a schematic view of a three-dimensional object shaping device according to a first embodiment.

FIG. 2 is a detailed view of a flattening roller unit shown in FIG. 1.

FIG. 3 is an explanatory view showing a configuration of a suction unit according to the first embodiment.

FIG. 4 is an explanatory view showing a configuration of a suction unit according to a second embodiment.

FIG. 5 is an explanatory view showing a configuration of a suction unit according to a third embodiment.

FIG. 6 is an explanatory view showing a configuration of a suction unit according to a fourth embodiment.

### DETAILED DESCRIPTION OF EMBODIMENTS

Embodiments according to the present disclosure will be described in detail below based on the drawings. It should be noted that the present disclosure is not to be limited by the embodiments. Furthermore, the constituent elements in the following embodiments include those that can be easily replaced by those skilled in the art, or those that are substantially the same. Moreover, the constituent elements described below can be appropriately combined, and when there are a plurality of embodiments, it is also possible to combine the respective embodiments.

### First Embodiment

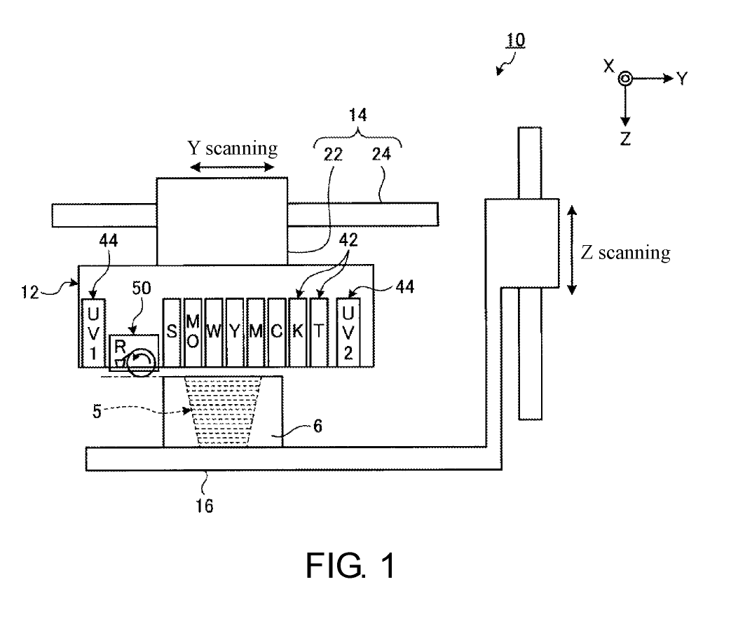

FIG. 1 is a schematic view of a three-dimensional object shaping device according to a first embodiment. A three-dimensional object shaping device 10 shown in FIG. 1 is a device for shaping a three-dimensional shaped object 5 by a layering shaping method. In this case, the layering shaping method is, for example, a method of shaping the shaped object 5 by overlapping a plurality of unit layers. The shaped object 5 is, for example, a three-dimensional structural object. In the three-dimensional object shaping device 10, for example, an ultraviolet curable ink (UV ink) is used as a shaping material.

The three-dimensional object shaping device 10 according to the first embodiment includes an ejection unit (supply section) 12, a main scanning driving section 14, a shaping table 16 serving as a mounting table for mounting the shaped object 5, and a control section 18. The ejection unit 12 is a portion that ejects a shaping material to become a material of the shaped object 5 as droplets, and forms each unit layer constituting the shaped object 5 by ejecting droplets or the like of a curable resin, which is a resin that cures according to a predetermined condition, and curing such resin. More specifically, the ejection unit 12 repeatedly performs over plural times, for example, a layer forming operation of forming a unit layer of a curable resin by ejecting droplets in accordance with an instruction of the control section 18, and a curing operation of curing the unit layer of the curable resin formed in the layer forming operation. The ejection unit 12 forms a plurality of unit layers of the cured curable resin in an overlapping manner by repeatedly carrying out such operations.

For the curable resin to be ejected from the ejection unit 12, for example, an ultraviolet curable resin that cures by irradiation of ultraviolet rays is used. In this case, the ejection unit 12 ejects, for example, ink droplets of an ultraviolet curable ink as liquid droplets to become the material of the shaped object 5. In the curing operation, the unit layer of the curable resin is cured by irradiating the ultraviolet rays from the ultraviolet light source. In this case, the unit layer of the curable resin is a layer formed by the ultraviolet curable ink.

Furthermore, in the three-dimensional object shaping device 10 according to the first embodiment, the ejection unit 12 ejects ink droplets containing colored ultraviolet curable ink to color the surface or the inside of the shaped object 5, thus shaping a colored shaped object 5. Moreover, the ejection unit 12 forms a support 6 at the periphery of the shaped object 5 at the time of shaping of the shaped object 5. The support 6 is a layered structural object (support layer) that supports the shaped object 5 being shaped and that enables shaping of an overhang shape, and is dissolved and removed by water or the like after the shaping of the shaped object 5 is completed.

The main scanning driving section 14 is a driving section for causing the ejection unit 12 to perform a main scanning operation. To cause the ejection unit 12 to perform the main scanning operation in the first embodiment means, for example, to cause the inkjet head of the ejection unit 12 to perform the main scanning operation. Furthermore, the main scanning operation is, for example, an operation of ejecting ink droplets while moving in a preset main scanning direction (Y direction in the drawing).

The main scanning driving section 14 includes a carriage 22 and a guide rail 24. The carriage 22 is a holding portion that holds the ejection unit 12 so as to face the shaping table 16. That is, the carriage 22 moves along the guide rail 24 while holding the ejection unit 12 at the time of the main scanning operation in which the carriage 22 holds the ejection unit 12 so that the ejecting direction of the ink droplets ejected from the ejection unit 12 is in a direction toward the shaping table 16. The guide rail 24 is a rail member that guides the movement of the carriage 22, and moves the carriage 22 in response to an instruction from the control section 18 at the time of the main scanning operation.

The movement of the ejection unit 12 at the time of the main scanning operation may be a relative movement with respect to the shaped object 5. Therefore, in a variant of the configuration of the three-dimensional object shaping device 10, the shaped object 5 side may be moved by, for example, fixing the position of the ejection unit 12 and moving the shaping table 16.

The shaping table 16 is a mounting table in which the shaped object 5 is mounted on the upper surface. The shaping table 16 has a function of moving the upper surface thereof in the up and down direction (Z direction in the drawing), and sequentially moves the upper surface in units of thickness of the unit layer every time the unit layer is formed in accordance with the progress in the shaping of the shaped object 5 according to the instruction of the control section 18. Scanning in the Z direction of moving the shaping table 16 up and down with respect to the ejection unit 12 may be carried out by moving the ejection unit 12 side in the Z direction.

The control section 18 is a device for controlling each section of the three-dimensional object shaping device 10, and includes a CPU (Central Processing Unit) functioning as a controller that executes various processes, a RAM (Random Access Memory), ROM (Read Only Memory), and the like functioning as a memory for storing various information. The control section 18 controls each section of the three-dimensional object shaping device 10 based on the shape information of the shaped object 5 to be shaped, the color image information, and the like to control the operation for shaping the shaped object 5.

The three-dimensional object shaping device 10 may further include various configurations necessary for shaping, coloring and the like of the shaped object 5. For example, the three-dimensional object shaping device 10 may include a sub-scanning driving section or the like for causing the ejection unit 12 to perform a sub-scanning operation. In this case, the sub-scanning operation is, for example, an operation of relatively moving the inkjet head in the ejection unit 12 in a sub-scanning direction (X direction in the figure) orthogonal to the main scanning direction with respect to the shaped object 5 being shaped. For example, in the case of shaping the shaped object 5 in which the length in the sub-scanning direction is longer than the shaping width (length in the X direction in the figure) of the inkjet head in the ejection unit 12, the sub-scanning driving section causes the ejection unit 12 to perform the sub-scanning operation, as necessary. More specifically, the sub-scanning driving section may be a driving section that moves the shaping table 16 in the sub-scanning direction, or may be a driving section that moves the guide rail 24 in the sub-scanning direction together with the carriage 22 holding the ejection unit 12.

The ejection unit 12 includes a plurality of inkjet heads 42 according to the type of ultraviolet curable ink used for shaping the three-dimensional shaped object 1. Furthermore, the ejection unit 12 includes a plurality of ultraviolet light sources 44 and a flattening roller unit 50.

The inkjet head 42 includes an inkjet head that ejects yellow (Y) color ink, an inkjet head that ejects magenta (M) color ink, an inkjet head that ejects cyan (C) color ink, and an inkjet head that ejects black (K) color ink. Furthermore, the inkjet head 42 includes an inkjet head that ejects white (W) color ink, an inkjet head that ejects transparent ink (T), an inkjet head that ejects support ink (S), and an inkjet head that ejects shaping ink (MO). These inkjet heads 42 are electrically connected to the control section 18, so that the drive thereof is controlled by the control section 18.

The plurality of ultraviolet light sources 44 are ultraviolet light sources that cure the ultraviolet curable ink, and an ultraviolet light emitting diode (LED), a metal halide lamp, a mercury lamp, and the like are used. Each of the plurality of ultraviolet light sources 44 is disposed on one end side and the other end side in the main scanning direction in the ejection unit 12. In the three-dimensional object shaping device 10 according to the first embodiment, UV1 and UV2 are provided as the ultraviolet light sources 44, where UV1 is disposed on one end side of the ejection unit 12 in the main scanning direction (Y direction) and UV2 is disposed on the other end side of the ejection unit 12 in the main scanning direction (Y direction).

The flattening roller unit 50 is a unit for flattening the unit layer of the ultraviolet curable ink formed during the shaping of the shaped object 5. The flattening roller unit 50 is disposed between the plurality of inkjet heads 42 and the UV1. That is, the flattening roller unit 50 is arranged side by side in the main scanning direction with the positions in the sub-scanning direction aligned with respect to the arrangement of the plurality of inkjet heads 42. The flattening roller unit 50 is provided on the ejection unit 12 so as to be movable in the up and down direction with respect to the ejection unit 12.

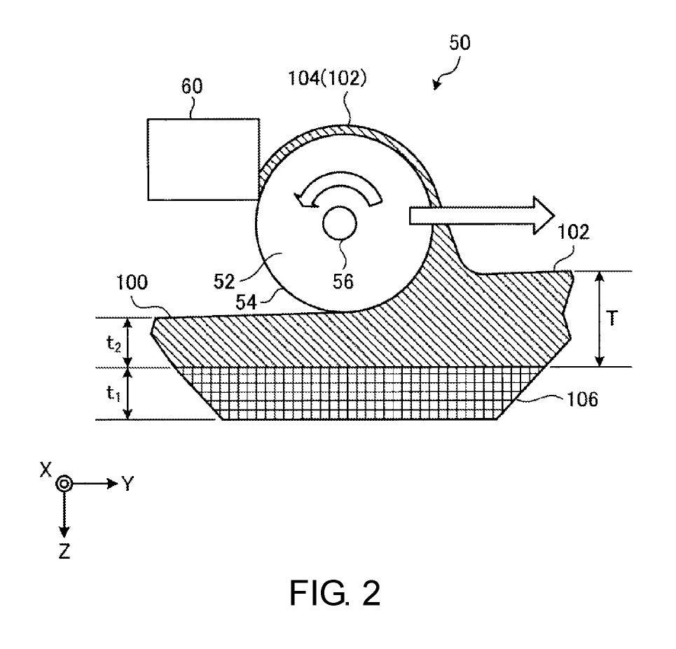

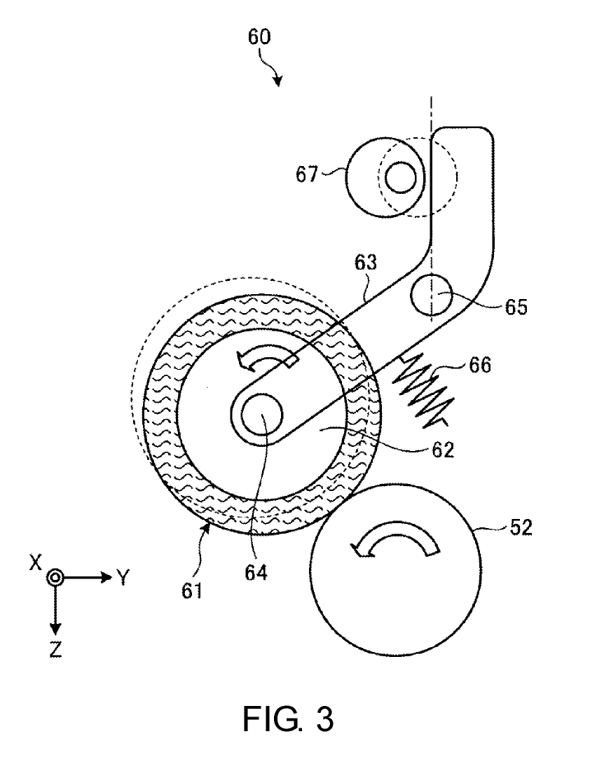

FIG. 2 is a detailed view of the flattening roller unit shown in FIG. 1, and FIG. 3 is an explanatory view showing a configuration of the suction unit according to the first embodiment. The flattening roller unit 50 includes a flattening roller 52 rotatably provided for scraping off the surplus shaping material 102 in the shaping material (shaping ink) 100 in a flowable state, that is, before curing, a rotating shaft 56 that supports the flattening roller 52 in a freely rotatable manner, and a suction unit 60 that collects the surplus shaping material 102. The flattening roller 52 is formed to a circular column shape and is disposed in such a direction that its axial direction extends in the sub-scanning direction (X direction). Since the function required for the surface of the flattening roller 52 is the wettability with respect to the surplus shaping material 102, the rotation accuracy and the lifespan, for example, a metallic roller having a surface 54 coated with a wear resistant coating such as chromium plating is preferred. The rotating shaft 56 supports the flattening roller 52 in a freely rotatable manner, and hence the rotating shaft 56 supports the flattening roller 52 in a direction of extending in the sub-scanning direction.

The flattening roller 52 uniformly forms the thickness (thickness in the Z direction) t1 of the unit layer 106. When the carriage 23 scans toward the right side (right side in FIG. 2) in the main scanning direction, the flattening roller 52 is rotated in the counterclockwise direction, so that the excess surplus shaping material 102 on the upper surface of the shaping material 100 constituting the unit layer is removed. The thickness T of the shaping material 102 before removal is thus set to the thickness t2 of the unit layer before the curing and after the removal, and such thickness t2 is set to the same thickness as the thickness t1 of the unit layer 106 after the curing.

Here, the surplus shaping material 102 refers to, for example, the shaping material ejected in excess without the shaping material becoming deficient in consideration of unevenness in thickness due to unevenness in the ejection amount in the scanning direction (X direction, Y direction) of the unit layer of the ink jet head 42, where the ratio of (T/t2) is 110% to 125%. Therefore, about 10% to 25% of the shaping material is scraped off by the flattening roller 52.

As shown in FIG. 3, the suction unit 60 is a unit that removes the surplus shaping material 102 from the flattening roller 52 by suctioning the surplus shaping material 102 attached to the flattening roller 52. The suction unit 60 includes a suction roller 61 serving a removing member, a roller rotation mechanism (contacting position changing mechanism) 62, an arm 63, a rotating shaft 64, a swing shaft 65, a spring 66, and a roller detachable cam 67.

The suction roller 61 is a cylindrical suction member that comes into contact with the flattening roller 52, and for example, a fiber such as polyester, a nonwoven fabric such as felt, a sponge, a paper, a cloth, and a composite thereof can be applied for the material. The suction roller 61 includes a removal region capable of absorbing the surplus shaping material 102 attached to the flattening roller 52, and the flattening roller 52 is brought into contact with a part of such removal region. The larger the outer diameter of the suction roller 61 and the thicker the suction portion thereof, the longer it is possible to use the suction roller 61. Furthermore, when an axial length (dimension in the X direction) of the suction roller 61 is set larger than that of the flattening roller 52, a soft suction portion goes around to the end face of the flattening roller 52, and the scraping ink can be prevented from flowing out from the end face.

The contacting position where the suction roller 61 makes contact with the flattening roller 52 is on the downstream side in the rotating direction than the apex position of the flattening roller 52. This is for the suction roller 61 to receive the cured ink (ink residue) contained in the surplus shaping material 102 suctioned by the suction roller 61.

The roller rotation mechanism 62 is a circular column shaped core member that rotates the suction roller 61, and the suction roller 61 is replaceably attached thereto. Furthermore, the roller rotation mechanism 62 and the suction roller 61 may be integrally, and the rotating shaft 64 may also be integrally replaceable. The roller rotation mechanism 62 is rotatable by a drive source (not shown), and for example, a drive source for rotating the flattening roller 52 is applied for the drive source. When using the drive source of the flattening roller 52, the roller rotation mechanism 62 is connected to the drive source through a power transmission gear, a pulley, and a belt so as to rotate in conjunction with the rotation of the flattening roller 52. Therefore, the roller rotation mechanism 62 branches the power transmitted from the drive source that drives the flattening roller 52 to the flattening roller 52, and rotates the suction roller 61 by the branched power. The roller rotation mechanism 62 continuously rotates the suction roller 61 at the time of rotation of the flattening roller 52, and stops the rotation of the suction roller 61 at the time of stopping the rotation of the flattening roller 52. Furthermore, a mechanism for intermittently rotating the suction roller 61 during the rotation of the flattening roller 52 may be provided in the roller rotation mechanism 62.

Here, the roller rotation mechanism 62 rotates the suction roller 61 so that the rotating direction of the suction roller 61 becomes an opposing direction at a contacting position with respect to the rotating direction of the flattening roller 52. That is, the roller rotation mechanism 62 rotates the rotating direction of the suction roller 61 so as to be in the same rotating direction as the rotating direction (counterclockwise direction in FIG. 3) of the flattening roller 52, so that the suction roller 61 and the flattening roller 52 are in opposing rotating directions at the above-mentioned contacting position. Thus, the roller rotation mechanism 62 changes the contacting position of the suction roller 61 that makes contact with the flattening roller 52 from one part of the removal region to another part of the removal region by rotating the suction roller 61. Furthermore, the roller rotation mechanism 62 makes the circumferential speed of the suction roller 61 slower than the circumferential speed of the flattening roller 52.

In the first embodiment, the drive source of the flattening roller 52 is applied to rotate the suction roller 61, but the present disclosure is not limited to this configuration, and a separate independently rotating drive source may be newly provided, and the suction roller 61 may be rotated by the newly provided drive source. In this case, the roller rotation mechanism 62 may continuously rotate the suction roller 61 or intermittently rotate the suction roller 61, for example, at the time of rotation of the flattening roller 52.

The rotating shaft 64 supports the suction roller 61 in a freely rotating manner around a center axis of the roller rotation mechanism 62, and is held by the arm 63. The rotating shaft 64 is disposed parallel to the rotating shaft 56 of the flattening roller 52 and is provided to extend in the sub-scanning direction.

The arm 63 holds the suction roller 61 and the roller rotation mechanism 62 by way of the rotating shaft 64, and is swingable about the swing shaft 65. The arm 63 is formed to include a portion connecting the swing shaft 65 and the rotating shaft 64 and a portion projecting out from the swing shaft 65 side and contacting the roller detachable cam 67 to be described later. The arm 63 moves the suction roller 61 to the contacting position by moving (swinging) toward the side of approaching the flattening roller 52 around the swing shaft 65, and moves the suction roller 61 to the separating position away from the flattening roller 52 by moving (swinging) toward the side of separating toward the flattening roller 52 around the swing shaft 65.

The swing shaft 65 serves as a center axis for swinging the suction roller 61 and the roller rotation mechanism 62 by way of the arm 63. The swing shaft 65 is disposed parallel to the rotating shaft 64 and is provided to extend in the sub-scanning direction.

The spring 66 is connected to the arm 63 and urges the suction roller 61 to move (swing) toward the side of approaching the flattening roller 52 around the swing shaft 65. A compression spring, for example, is applied for the spring 66.

The roller detachable cam 67 is provided so as to be able to come in contact with a predetermined portion of the arm 63, and moves (swings) the suction roller 61 to the side of separating away from the flattening roller 52 around the swing shaft 65 against the urging force of the spring 66. The roller detachable cam 67 is an eccentric cam that rotates around a center axis, and changes the cam surface formed on the outer periphery. The cam surface includes a surface for moving the suction roller 61 to the contacting position and a surface for moving the suction roller 61 to the separating position in the 180° direction. As a rotational drive source of the roller detachable cam 67, a drive source (not shown), for example, a drive source such as a pulse motor can be used.

When using the flattening roller 52, that is, when scraping off the surplus shaping material 102 in the shaping material 100 forming the unit layer, the suction unit 60 moves the arm 63 to the side of approaching the flattening roller 52 by the roller detachable cam 67 to move the suction roller 61 to the contacting position. Then, the suction roller 61 suctions and removes the surplus shaping material 102 attached to the flattening roller 52 while rotating at a circumferential speed slower than that of the flattening roller 52. On the other hand, when the flattening roller 52 is not in use, that is, when the flattening roller 52 is away from the shaping material 100, the suction unit 60 moves the arm 63 to the side of separating away from the flattening roller 52 by the roller detachable cam 67 to move the suction roller 61 to the separating position. The timing of movement of the suction roller 61 to the contacting position and the separating position may be a predetermined timing, and is not particularly limited.

The suction roller 61 may be impregnated with a cleaning liquid in order to suitably remove the surplus shaping material 102. Furthermore, the suction roller 61 may be formed into a cartridge so that it can be replaced easily. Moreover, the suction roller 61 may use the usage amount of the shaping material 100 used for the shaped object 5 as an indication of replacement, in which case, the control section 18 of the three-dimensional object shaping device 10 may inform the replacement timing of the suction roller 61.

Therefore, according to the first embodiment, the surplus shaping material 102 attached to the flattening roller 52 can be suctioned by the suction roller 61 by bringing the suction roller 61 into contact with the flattening roller 52. Therefore, a configuration in which the storage tank for storing the surplus shaping material 102 and the suction pump connected to the storage tank, the suction tube, and the blade bridged from the flattening roller 52 to the storage tank are omitted can be adopted. The occurrence of overflow of the shaping material from the storage tank due to clogging of the ink residue in the suction tube thus can be suppressed. Furthermore, the occurrence of drooping of the shaping material from the blade due to attachment of ink residue to the blade can be suppressed. Therefore, the surplus shaping material 102 attached to the flattening roller 52 can be more appropriately collected by the suction roller 61.

Furthermore, according to the first embodiment, the contacting position of the suction roller 61 can be changed by rotating the suction roller 61 by the roller rotation mechanism 62. Therefore, since the portion of the suction roller 61 that suctions the surplus shaping material 102 can be changed, the suction roller 61 can be used for a long term, and the frequency of replacement of the suction roller 61 can be reduced.

Moreover, according to the first embodiment, the contacting position of the suction roller 61 can be changed using the drive source of the flattening roller 52. In the first embodiment, the drive source of the flattening roller 52 is used, but the present disclosure is not limited to this configuration. For example, the suction roller 61 may be rotated by a drive source different from the drive source for driving the flattening roller 52. Furthermore, the suction roller 61 may be brought into contact with the flattening roller 52, and the suction roller 61 may be rotated by being driven by the rotation of the flattening roller 52. In this case, the rotating direction of the suction roller 61 is the same direction at the contacting position with respect to the rotating direction of the flattening roller 52.

Furthermore, according to the first embodiment, the surplus shaping material 102 attached to the flattening roller 52 can be suitably suctioned by moving the suction roller 61 in the direction opposing the rotating direction of the flattening roller 52 at the contacting position. Moreover, the suction roller 61 can be used for a longer term, and the frequency of replacement of the suction roller 61 can be reduced by having the circumferential speed of the suction roller 61 slower than the circumferential speed of the flattening roller 52.

### Second Embodiment

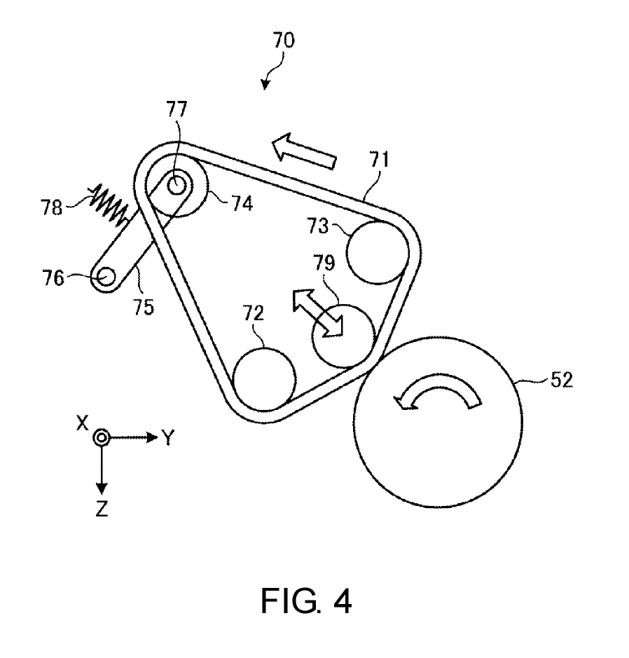

Next, a suction unit 70 according to a second embodiment will be described with reference to FIG. 4. In the second embodiment, portions different from the first embodiment will be described, and portions having the same configuration as in the first embodiment will be described with the same reference numerals in order to avoid redundant description. FIG. 4 is an explanatory view showing a configuration of a suction unit according to the second embodiment.

The suction unit 60 of the first embodiment suctions the surplus shaping material 102 attached to the flattening roller 52 using the suction roller 61, but a suction unit 70 of the second embodiment suctions the surplus shaping material 102 attached to the flattening roller 52 using an endless belt.

The suction unit 70 of the second embodiment includes an endless belt 71 serving as a removing member, a plurality of driven rollers 72, 73, a driving roller 74, an arm 75, a swing shaft 76, a rotating shaft 77, a spring 78, and a detachable roller 79.

The endless belt 71 is an endless suction member that makes contact with the flattening roller 52, and for example, a fiber such as polyester, a nonwoven fabric such as felt, a sponge, a paper, cloth, and a composite material thereof can be applied for the material, similar to the suction roller 61 of the first embodiment. The endless belt 71 has a removal region capable of absorbing the surplus shaping material 102 attached to the flattening roller 52, and the flattening roller 52 is brought into contact with a part of such removal region.

The endless belt 71 has a contacting position of making contact with the flattening roller 52 at a position on a lower side, which is the downstream side in the rotating direction of the flattening roller 52, with respect to the apex position of the flattening roller 52, similar to the suction roller 61 of the first embodiment.

The plurality of driven rollers 72, 73 and the driving roller 74 are belt circulating mechanisms (contacting position changing mechanisms) for circulating the endless belt 71. Two of the plurality of driven rollers 72, 73 are provided in the second embodiment, where the two driven rollers 72, 73 and the driving roller 74 are disposed so as to be located at the apices of a triangular shape. That is, the two driven rollers 72, 73 are disposed on the upstream side and the downstream side of the endless belt 71 with the flattening roller 52 interposed therebetween, and the driving roller 74 is disposed at the position on the opposite side of the flattening roller 52 between the endless belts 71 bridged over the two driven rollers 72, 73. The endless belt 71 is bridged over the two driven rollers 72, 73 and the driving roller 74, and the endless belt 71 is circulated when the driving roller 74 is rotated.

As in the case of the roller rotation mechanism 62 of the first embodiment, the driving roller 74 circulates the endless belt 71 such that the transport direction of the endless belt 71 is an opposing direction with respect to the rotating direction of the flattening roller 52 at the contacting position. For this reason, the driving roller 74 circulates the endless belt 71, thereby changing the contacting position of the endless belt 71 that makes contact with the flattening roller 52 from one part of the removal region to another part of the removal region. Furthermore, the driving roller 74 makes the transporting speed of the endless belt 71 slower than the circumferential speed of the flattening roller 52. As the drive source of the driving roller 74, the drive source of the flattening roller 52 may be used, or a newly provided drive source may be used. Moreover, although the driving roller 74 is driven, for example, the driven roller 73 may be driven.

The rotating shaft 77 is a center axis of the driving roller 74, and supports the driving roller 74 in a freely rotatable manner, and is held by an arm 75 to be described later. The rotating shaft 77 is disposed parallel to the rotating shaft 56 of the flattening roller 52 and is provided to extend in the sub-scanning direction.

The arm 75 holds the driving roller 74 by way of the rotating shaft 77 and is capable of swinging about the swing shaft 76. The arm 75 is formed by connecting the swing shaft 76 and the rotating shaft 77, and applies a tension to the endless belt 71 by the spring 78.

The swing shaft 76 serves as a center axis for swinging the driving roller 74 by way of the arm 75. The swing shaft 76 is disposed in parallel to the rotating shaft 64 and is provided to extend in the sub-scanning direction.

The spring 78 is connected to the arm 75 and urges the driving roller 74 so as to apply tension to the endless belt 71 around the swing shaft 76. For example, a tension spring is applied to the spring 78.

The detachable roller 79 is a driven roller provided in contact with the endless belt 71 bridged between the two driven rollers 72 and 73 and is provided on the opposite side of the flattening roller 52 with the endless belt 71 in between. The detachable roller 79 moves toward the side of approaching the flattening roller 52, thereby moving the endless belt 71 to the contacting position of making contact with the flattening roller 52. On the other hand, the detachable roller 79 moves toward the side of separating away from the flattening roller 52, thereby moving the endless belt 71 to the separating position of separating away from the flattening roller 52.

When using the flattening roller 52, that is, when scraping off the surplus shaping material 102 in the shaping material 100 forming the unit layer, the suction unit 70 removes the endless belt 71 to the side of making contact with the flattening roller 52 with the detachable roller 79 thereby moving the endless belt 71 to the contacting position. The endless belt 71 removes the surplus shaping material 102 attached to the flattening roller 52 while moving at a transporting speed slower than the circumferential speed of the flattening roller 52. On the other hand, when the flattening roller 52 is not in use, that is, when the flattening roller 52 is away from the shaping material 100, the suction unit 70 moves the endless belt 71 to the side of separating away from the flattening roller 52 by the detachable roller 79 to move the endless belt 71 to the separating position. The timing of moving the endless belt 71 to the contacting position and the separating position may be a predetermined timing, and is not particularly limited.

The endless belt 71 may be impregnated with a cleaning liquid in order to suitably remove the surplus shaping material 102. Furthermore, the endless belt 71 may be formed into a cartridge so that it can be replaced easily. Moreover, the endless belt 71 may use the usage amount of the shaping material 100 used for the shaped object 5 as an indication of replacement, in which case, the control section 18 of the three-dimensional object shaping device 10 may inform the replacement timing of the endless belt 71.

As described above, according to the second embodiment, the surplus shaping material 102 attached to the flattening roller 52 can be suctioned by the endless belt 71 by bringing the endless belt 71 into contact with the flattening roller 52. Therefore, the surplus shaping material 102 attached to the flattening roller 52 can be appropriately collected by the endless belt 71. Furthermore, an advantage in that a suction dimension longer than the peripheral length of the suction roller 61 of the first embodiment can be obtained, and the interval of replacement timing becomes longer is obtained.

### Third Embodiment

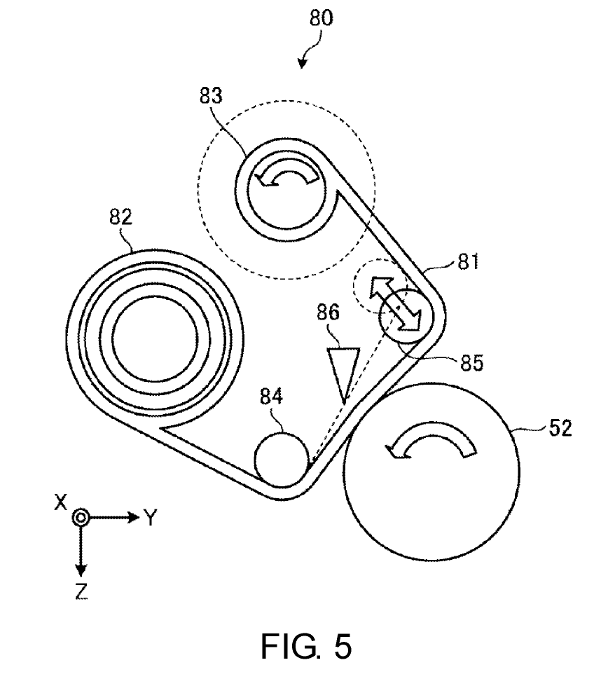

Next, a suction unit 80 according to a third embodiment will be described with reference to FIG. 5. In the third embodiment as well, portions different from the first and second embodiments will be described, and portions having the same configuration as in the first and second embodiments will be described with the same reference numerals in order to avoid redundant description. FIG. 5 is an explanatory view showing the configuration of the suction unit according to the third embodiment.

The suction unit 60 of the first embodiment suctions the surplus shaping material 102 attached to the flattening roller 52 using the suction roller 61, but the suction unit 80 of the third embodiment uses a web 81 to suction the surplus shaping material 102 attached to the flattening roller 52.

The suction unit 80 of the third embodiment includes the web 81 serving as a removing member, a feeding roll 82, a winding roller 83, a guide roller 84, a detachable roller 85, and a cleaning nozzle 86.

Similar to the suction roller 61 of the first embodiment, the web 81 is a web-like suction member that is fed out from the feeding roll 82 and wound around the winding roller 83, and for example, a fiber such as polyester, a nonwoven fabric such as felt, a sponge, a paper, a cloth, and a composite thereof can be applied as the material. The web 81 has a removal region capable of absorbing the surplus shaping material 102 attached to the flattening roller 52, and the flattening roller 52 is brought into contact with one part of such removal region.

The feeding roll 82 is a roll for winding the web 81 into a roll form, and feeds the wound roll-like web 81 toward the flattening roller 52 by applying a feeding drag (not illustrated) by friction or the like. Tension is applied to the web 81 fed out from the feeding roll 82 by the feeding drag. The winding roll 83 is a roll for winding up the web 81 after contacting the flattening roller 52, and collects the used web 81. The winding roll 83 is driven in the winding direction and functions as a rotation mechanism (contacting position changing mechanism).

Similar to the roller rotation mechanism 62 of the first embodiment, the winding roller 83 transports the web 81 such that the transport direction of the web 81 is an opposing direction at the contacting position with respect to the rotating direction of the flattening roller 52. Therefore, the winding roll 83 changes the contacting position of the web 81 contacting the flattening roller 52 from one part of the removal region to another part of the removal region by transporting the web 81. Furthermore, the winding roll 83 makes the transporting speed of the web 81 slower than the circumferential speed of the flattening roller 52. Moreover, a drive source of the flattening roller 52 may be used, or a newly provided drive source may be used for the drive source of the winding roller 83.

The guide roller 84 is provided on the web 81 between the feeding roll 82 and the winding roller 83 and is disposed on the upstream side in the transport direction of the web 81 with respect to the flattening roller 52. The guide roller 84 is a driven roller and guides the web 81 fed out from the feeding roll 82 toward the flattening roller 52.

The detachable roller 85 is provided on the web 81 between the feeding roll 82 and the winding roller 83 and is disposed on the downstream side in the transport direction of the web 81 with respect to the flattening roller 52. The detachable roller 85 is a driven roller, and guides the web 81 transported from the flattening roller 52 toward the winding roller 83. Furthermore, the detachable roller 85 moves toward the side of approaching the flattening roller 52, thereby moving the web 81 to the contacting position of making contact with the flattening roller 52. On the other hand, the detachable roller 85 moves toward the side of separating away from the flattening roller 52, thereby moving the web 81 to the separating position of separating away from the flattening roller 52.

The cleaning nozzle 86 is provided on the opposite side of the flattening roller 52 with the web 81 in between. The cleaning nozzle 86 ejects a cleaning liquid on the web 81 located on the upstream side in the transport direction with respect to the flattening roller 52. Therefore, the web 81 in contact with the flattening roller 52 is the web 81 impregnated with the cleaning liquid, so that the web 81 is prevented from solidifying and the surface of the flattening roller 52 is cleaned by the surplus shaping material 102 attached to the web 81.

When using the flattening roller 52, that is, when scraping off the surplus shaping material 102 in the shaping material 100 forming the unit layer, the above-described suction unit 80 causes the web 81 to move to the side of approaching the flattening roller 52 by the detachable roller 85 to move the web 81 to the contacting position. Then, the web 81 removes the surplus shaping material 102 attached to the flattening roller 52 while moving at a transporting speed slower than the circumferential speed of the flattening roller 52. At this time, the web 81 is impregnated with the cleaning liquid by spraying the cleaning liquid toward the web 81 from the cleaning nozzle 86. On the other hand, when the flattening roller 52 is not in use, that is, when the flattening roller 52 is away from the shaping material 100, the suction unit 80 moves the web 81 to the side of separating away from the flattening roller 52 by the detachable roller 85 to move the web 81 to the separating position. The timing of the movement of the web 81 to the contacting position and the separating position may be a predetermined timing, and is not particularly limited.

Furthermore, the web 81 may be formed into a cartridge so that it can be replaced easily. Moreover, the web 81 may use the usage amount of the shaping material 100 used for the shaped object 5 as an indication of replacement, in which case, the control section 18 of the three-dimensional object shaping device 10 may inform the replacement timing of the web 81.

As described above, according to the third embodiment, the surplus shaping material 102 attached to the flattening roller 52 can be suctioned by the web 81 by bringing the web 81 into contact with the flattening roller 52. Therefore, the surplus shaping material 102 attached to the flattening roller 52 can be appropriately collected by the web 81. Furthermore, since the feed length of the web 81 is longer than in the first and second embodiments, an advantage in that the interval of the replacement timing becomes longer is obtained. Furthermore, since the contact length between the web 81 and the flattening roller 52 is longer than in the first and second embodiments, an advantage in that the capability of suctioning is higher is obtained.

### Fourth Embodiment

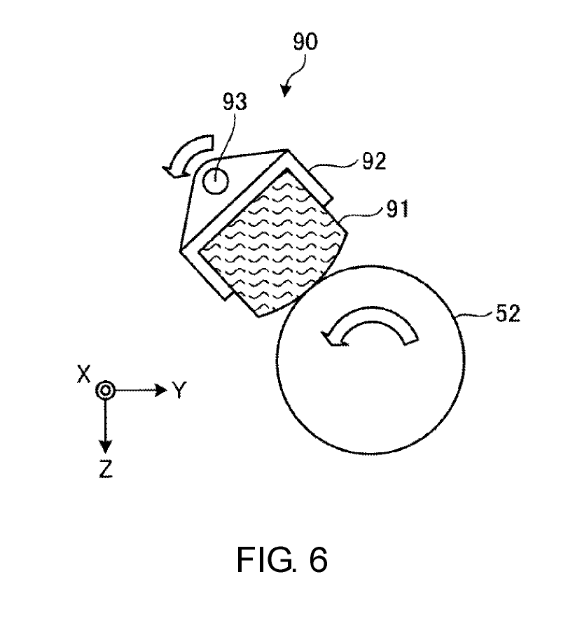

Next, a suction unit 90 according to a fourth embodiment will be described with reference to FIG. 6. In the fourth embodiment as well, portions different from the first to third embodiments will be described, and portions having the same configuration as in the first to third embodiments will be described with the same reference numerals in order to avoid redundant description. FIG. 6 is an explanatory view showing a configuration of a suction unit according to the fourth embodiment.

The suction unit 60 of the first embodiment suctions the surplus shaping material 102 attached to the flattening roller 52 using the suction roller 61, but the suction unit 90 of the fourth embodiment suctions the surplus shaping material 102 attached to the flattening roller 52 using a suction pad.

The suction unit 90 of the fourth embodiment includes a suction pad 91 serving as a removing member, a casing 92, and a swing shaft 93.

The suction pad 91 is a rod-like suction member provided so as to extend in the axial direction (sub-scanning direction) of the rotating shaft 56 of the flattening roller 52, and for example, a fiber such as polyester, a nonwoven fabric such as felt, a sponge, a paper, a cloth, and a composite thereof can be applied for the material, similar to the suction roller 61 of the first embodiment. The suction pad 91 includes a removal region capable of absorbing the surplus shaping material 102 attached to the flattening roller 52, and the flattening roller 52 is brought into contact with a part of such removal region. Furthermore, the suction pad 91 has a surface on a distal end side that makes contact with the flattening roller 52 formed to, for example, a curved surface that is convex toward the outer side.

The casing 92 interiorly holds the suction pad 91. The casing 92 is swingable about the swing shaft 93. The casing 92 swings around the swing shaft 93, thereby changing the contacting position of the suction pad 91 with respect to the flattening roller 52.

The swing shaft 93 serves as a center axis for swinging the suction pad 91 by way of the casing 92. The swing shaft 93 is disposed parallel to the direction in which the suction pad 91 is extended, and is provided to extend in the sub-scanning direction. The swing shaft 93 swings the suction pad 91 so that the direction in which the suction pad 91 moves is a direction opposing the rotating direction of the flattening roller 52 at the contacting position. Therefore, the swing shaft 93 functions as a swinging mechanism (contacting position changing mechanism) for swinging the suction pad 91, and changes the contacting position of the suction pad 91 in contact with the flattening roller 52 from one part of the removal region to another part of the removal region. Furthermore, the swing shaft 93 makes the moving speed of the suction pad 91 slower than the circumferential speed of the flattening roller 52.

When using the flattening roller 52, that is, when scraping off the surplus shaping material 102 in the shaping material 100 forming the unit layer, the suction unit 90 described above removes the surplus shaping material 102 attached to the flattening roller 52 while moving the suction pad 91 at a moving speed slower than the flattening roller 52.

In the fourth embodiment, the detachable mechanism for moving the suction pad 91 between the contacting position and the separating position is omitted, but the detachable mechanisms as described in the first to third embodiments may be provided. Furthermore, the suction pad 91 may be impregnated with a cleaning liquid in order to suitably remove the surplus shaping material 102. Moreover, the suction pad 91 may be formed into a cartridge so that it can be replaced easily. In addition, the suction pad 91 may use the usage amount of the shaping material 100 used for the shaped object 5 as an indication of replacement, in which case, the three-dimensional object shaping device 10 may inform the replacement timing of the suction pad 91.

As described above, according to the fourth embodiment, the surplus shaping material 102 attached to the flattening roller 52 can be suctioned by the suction pad 91 by bringing the suction pad 91 into contact with the flattening roller 52. Therefore, the surplus shaping material 102 attached to the flattening roller 52 can be appropriately collected by the suction pad 91. Although the suction capability is inferior to those of the first embodiment, the second embodiment and the third embodiment, the mechanism is simple and inexpensive, and it has an advantage that replacement can be easily performed.

What is claimed is:

1. A three-dimensional object shaping device that shapes a three-dimensional object by layering a plurality of unit layers, wherein each unit layer of the plurality of unit layers is formed by ejecting a shaping material on a shaping table from a supply section that supplies the shaping material, the three-dimensional object shaping device comprising:
a flattening roller that makes contact with a surface side of the unit layer to scrape off a surplus shaping material, and flattens a surface of the unit layer; and
a removing member that is brought into contact with the flattening roller to remove the shaping material attached to the flattening roller.

2. The three-dimensional object shaping device according to claim 1, wherein the removing member includes a removal region for removing the shaping material, the flattening roller is brought into contact with one part of the removal region; and
a contacting position changing mechanism that changes a contacting position of the removing member in contact with the flattening roller from one part of the removal region to another part of the removal region is further arranged.

3. The three-dimensional object shaping device according to claim 2, wherein the contacting position changing mechanism changes the contacting position of the removing member by a drive source different from a drive source for driving the flattening roller, or the contacting position changing mechanism changes the contacting position of the removing member by a power branched from a power transmitted from the drive source for driving the flattening roller to the flattening roller, or the contacting position changing mechanism changes the contacting position of the removing member by making contact with the flattening roller to be driven by a rotation of the flattening roller.

4. The three-dimensional object shaping device according to claim 3, wherein when using the drive source different from the drive source for driving the flattening roller or when using the power branched from the power transmitted from the drive source for driving the flattening roller to the flattening roller, the contacting position changing mechanism moves the removing member in a direction opposing a rotating direction of the flattening roller to change the contacting position of the removing member; and
a moving speed of the removing member is slower than a circumferential speed of the flattening roller.

5. The three-dimensional object shaping device according to claim 2, wherein the removing member is a suction roller that makes contact with the flattening roller; and
the contacting position changing mechanism is a roller rotation mechanism that rotates the suction roller.

6. The three-dimensional object shaping device according to claim 2, wherein the removing member is an endless belt that makes contact with the flattening roller, and
the contacting position changing mechanism is a belt circulating mechanism that circulates the endless belt.

7. The three-dimensional object shaping device according to claim 2, wherein the removing member is a web that makes contact with the flattening roller, and is fed out from a feeding roll and wound around a winding roll, and
the contacting position changing mechanism is a winding roll rotation mechanism that rotates the winding roll.

8. The three-dimensional object shaping device according to claim 1, further comprising a cleaning nozzle that sprays cleaning liquid for removing the shaping material on the removing member.
